(19) United States
(12) Patent Application Publication
(10) Pub. No.: US 2018/0288035 A1
(43) Pub. Date: Oct. 4, 2018

(54) DEVICE ENROLLMENT SERVICE SYSTEM AND METHOD

(71) Applicant: AVAYA INC., Santa Clara, CA (US)

(72) Inventor: Rifaat Shekh-Yusef, Ontario (CA)

(21) Appl. No.: 15/868,783

(22) Filed: Jan. 11, 2018

Related U.S. Application Data
(60) Provisional application No. 62/479,089, filed on Mar. 30, 2017.

(51) Int. Cl. H04L 29/06; G06F 17/30

(52) U.S. Cl. CPC H04L 63/0823; G06F 17/30377; G06F 17/3033; H04L 63/06

(57) ABSTRACT

Endpoints, such as Session Initial Protocol enabled telephones, are capable of being public network (e.g., Internet) devices and, as such, require security measures to protect the endpoints and components on a private network they may be attached to, such as a call center. By providing a self-signed certificate into an endpoint with hardcoded certificate authorities (CAs) that enable the phone to call a trusted location, namely a Device Enrollment Service (DES) having a verifiable record of the endpoint that, on endpoint startup, authentication actions may be performed and, is successful, the endpoint is permitted to “point to” other services that may allow the endpoint to be redirected or otherwise use a particular private network, such as that of a customer.

### CROSS-REFERENCE TO RELATED APPLICATIONS

The present application claims the benefit of Provisional Patent Application No. 62/479,089, filed on Mar. 30, 2017, and is incorporated herein by reference in its entirety.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for telecommunication components and methods and more particularly to adding trusted nodes.

### BACKGROUND

In the prior art, the way that endpoints are deployed securely and sent to the customer is through a third-party reseller. Resellers sell endpoints, from the factory, that are not specific to a particular customer. The third-party creates a staging area, loads certificates, configures the endpoints specifically for a particular customer, and sends the endpoints to the customer. The third-party makes it possible for customers to be able to securely deploy endpoints by simply plugging them in to a network where the phone then self-register. It is often inefficient to have an intermediary and a staging area to set up endpoints, however, shipping endpoints directly to customers, where the endpoints then configure themselves, creates security vulnerabilities.

### SUMMARY

These and other needs are addressed by the various embodiments and configurations of the present invention. The present invention can provide a number of advantages depending on the particular configuration. These and other advantages will be apparent from the disclosure of the invention(s) contained herein.

The proposed solutions solves these and other issues by providing a secure redirection service for endpoints and thereby enable endpoints to be directly shipped to customers, including allowing service provider association and providing a provisioning Uniform Resource Locator (URL), while reducing or eliminating, the potential for misuse by a nefarious actor, whether human and/or software.

In one embodiment, systems and methods are described in order to provide a direct-to-customer solution that allows for the secure configuration, authentication, and registration of endpoints from a customer site. In one embodiment, an endpoint may be a digital telephone, such as utilizing Session Imitation Protocol (SIP) and/or other packet-based protocol, softphone (e.g., digital telephonic component embodied on a computing device, such as a personal computer), smartphone, and/or other device comprising packet-based communication components. In another embodiment, endpoints are limited to physical devices (e.g., telephones) that may be physically provided to a location for use via attachment to a location-specific network or network portion. Endpoints may utilize additional or alternative forms of digital media communication, such as video, chat, email, co-browse, etc. Endpoints may also incorporate other features, such as analog telephony, computing components, etc.

In one embodiment, a Device Enrollment Service (DES) is described and may be deployed on a private and/or public network (e.g., the Internet). The DES may have multiple interfaces, including one or more of, but not limited to:
Administrator interface, to enable an enterprise to manage the services provided by the DES and to load the endpoint certificates, with their associated media access control address (MAC address), onto endpoints;
Manufacturer interface, to enable a manufacturer of the endpoint to load the certificates to the DES;
Service Provider interface, to enable the service provider to manage the service provider's own profile on the DES and associate endpoints to the service provider's profile;
Reseller interface, to enable resellers to associate endpoints with their service provider profile; and
Endpoints interface, a programmatic application program interface (API) to enable endpoints to be authenticated and redirected to connect to a specific service provider's interface.

In another embodiment, new tests/commands are introduced to perform one or more of:
Create a self-signed certificate on an endpoint;
Fetch a hash of the self-signed certificate, store the hash in a database (DB), and associate the hash with an individual endpoint's MAC address; and
The hashes, and their associated MAC addresses, may then be uploaded to the DES, such as one or more DES servers.

In another embodiment, service providers (SP) update their profile on the DES system to allow resellers to associate endpoints with the reseller's profile. The service provider profile includes one or more, and preferably each, of:
A provisioning URL(s); and
A Certificate Authority (CA) certificate to validate the provisioning server certificate, when the certificate is not signed by a public CA trusted by the endpoint;

The reseller may associate a list of endpoints with a specific SP by associating the MAC addresses of each of the endpoints with the SP profile.

In another embodiment, when a self-signed certificate expires or is compromised, the DES will remove the certificate from the DES DB, and a new locally generated self-signed certificate is then associated with the DES using the Access Key mechanism that securely introduces the certificate to the DES.

DES—Service Provider Profile Creation: In one embodiment, an SP logs into their account and creates an SP profile to allow the DES to redirect endpoints to the Service Provider Provisioning service. The SP profile includes a sp-validation-key-pair, created by DES, with the sp-validation-private-key maintained on the DES and the sp-validation-public-key maintained by the Service Provider, to later allow the Service Provider to validate signed requests from the DES. The profile may also include a sp-profile-key-pair, created by the SP, with the sp-profile-private-key maintained by the Service Provider and the sp-profile-public-key maintained on the DES, to later allow the DES to validate signed requests from the SP. In another embodiment, every change/update to the profile by the SP must be signed with their sp-profile-private-key. When the SP sells a service to a customer, and the customer orders endpoints from a reseller, the SP updates their profile to later allow the reseller to associate endpoints with the reseller's profile for a specific customer. When a SP directly sells an endpoint to a customer, the SP updates the SP's profile to associate the endpoints with the customer domain.

A benefit of using key-pairs instead of Public Key Infrastructure (PKI) certificate is to avoid the need for the PKI infrastructure and its complexities. However, in another embodiment, PKI certificates may be utilized.

DES—Reseller Endpoint Association: An enterprise creates an account for a reseller to login to and associate endpoints with particular SPs. As part of this setup process, the reseller creates a rs-profile-key-pair associated with the reseller; the rs-profile-private-key stays with the reseller, and the rs-profile-public-key is provided to the DES.

DES—First Install. In one embodiment, if the certificate provided to the DES is signed by a “non-factory” CA, the endpoint will prompt the user for approval. As a benefit, this will help avoid the potential risk of an attacker loading new CA certificates to a server and then pointing the endpoint to a malicious server in order to attempt a take-over the endpoint.

Step 1. An endpoint boots for the first time, and establishes a mutually authenticated channel with the DES using the self-signed certificate.

Step 2. POST /config. In one embodiment, the endpoint sends a request to the DES to receive configuration information and configure itself with the address of the configuration server.

Step 3. SIP message “301” (“moved permanently”) with a current location header for the endpoint (e.g., a URL). The DES then redirects the endpoint to the Service Provider, and provides the endpoint with the signature of the endpoint's self-signed certificate, signed using the sp-validation-private-key in the payload.

Step 4. The endpoint establishes a server-authenticated channel with a server of the SP.

Step 5. POST /config: The endpoint then sends the self-signed certificate and the DES signature to the SP to validate that the certificate was provided by the DES using the sp-validation-public-key. As a result, the endpoint has configuration details to enable use on the Session Initiation Protocol (SIP) network.

Here to, a benefit of using key-pairs instead of a full-fledged certificate is to avoid the use of PKI infrastructure that comes with the use of a PKI certificate.

D. Public certificate authority or certification authority (CA):
In one embodiment, the endpoints are configured by the manufacturer with a hardcoded list of Public CAs. Optionally, the endpoint may be loaded with new CA certificates to be used instead of, or in addition to, the hardcoded certificates.
To prevent an attacker from hijacking the endpoint if, during transition (e.g., shipment of the endpoint to the end customer) the endpoint gets loaded with malicious CA, the endpoint will always prompt the user when the endpoint tries to connect to the DES when the CA used is a non-hardcoded CA. A user must either give the endpoint permission to proceed or erase the non-hardcoded CA. The hardcoded CAs may still be used.

Risks associated with a successful attack. If an endpoint is attacked, the endpoint may be provided with a CA that points to a malicious configuration server. The endpoint will not reach out to the expected configuration server, and will therefore not be able to obtain software to provide services. The absence of the services may then be detected by an administrator for the endpoint. As a benefit, a non-authorized and/or malicious software masquerading as an endpoint, will not be able to enroll the endpoint with the DES system.

Endpoint Enrollment in Factory State. To be able to reclaim a specific endpoint, the endpoint must be released either by the current owner, or by an enterprise's administrator. If the endpoint is reset by the administrator, then the administrator should notify the SP for that endpoint.

Disable DES Feature: In another embodiment, a new vendor-specific Dynamic Host Configuration Protocol (DHCP) allows the customer to disable the DES feature such that and endpoint will retain the disabled DES settings and cease future attempts to connect to the DES. A reset to factory defaults would be needed to change the endpoint's behavior after it obtained provisioning information.

For remote users, we have two options. First, pre-stage the endpoint and second, add a timed user prompt to allow the user to instruct the endpoint not to connect to the DES. If the user does not provide the appropriate feedback, the endpoint will continue and contact the DES service.

In one embodiment, a system is disclosed, comprising: a network interface; a data storage comprising a non-volatile portion; a processor; and wherein, the processor, upon determining a first attachment to a network: accesses a first address within the data storage; attempt mutual authentication with a first service provided at the first address; upon successfully performing mutual authentication with the first service, receiving from the first service a certificate a second address and a signed certificate; and reconfiguring the system to communicate with a second service at the second address.

In another embodiment, a system, comprising: a data storage; a processor; a network interface; and wherein the processor: receives, via the network interface, a request for mutual authentication from an endpoint; in response to the received request, performs mutual authentication with the endpoint; upon successfully performing the mutual authentication, providing the endpoint with a certificate to enable the endpoint to utilize a network.

In another embodiment, a system, comprising: a data storage; a processor; a network interface; and wherein the processor: receives, via the network, a certificate from an endpoint; upon receiving the certificate, validates the certificate utilizing a public key maintained in the data storage; and upon successfully validating the certificate, adding the endpoint to a list of trusted endpoints to thereby enable the endpoint to utilize a network.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a third system in accordance with embodiments of the present disclosure;

FIG. 4 depicts a first interaction in accordance with embodiments of the present disclosure;

FIG. 5 depicts a second interaction in accordance with embodiments of the present disclosure;

FIG. 6 depicts a third interaction in accordance with embodiments of the present disclosure;

FIG. 7 depicts a fifth interaction in accordance with embodiments of the present disclosure;

FIG. 8 depicts a sixth interaction in accordance with embodiments of the present disclosure;

FIG. 9 depicts a seventh interaction in accordance with embodiments of the present disclosure;

FIG. 10 depicts an eighth interaction in accordance with embodiments of the present disclosure;

FIG. 11 depicts a ninth interaction in accordance with embodiments of the present disclosure;

FIG. 12 depicts a tenth interaction in accordance with embodiments of the present disclosure; and

FIG. 13 depicts a first-installation interaction in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

Furthermore, the term “certificate,” refers cryptographic digital data files utilized to certify, at least in part, an electronic computational device.

The term, “signature,” as used herein, is a data scheme or the result of other algorithmic operation such as to generate a hash, at least in part, from a private key and may be validated using a certificate associated with the private key.

At no point does the term “signature” or “certificate,” as used herein, refer to the act a human signing or the presence of a human signature on a physical document.

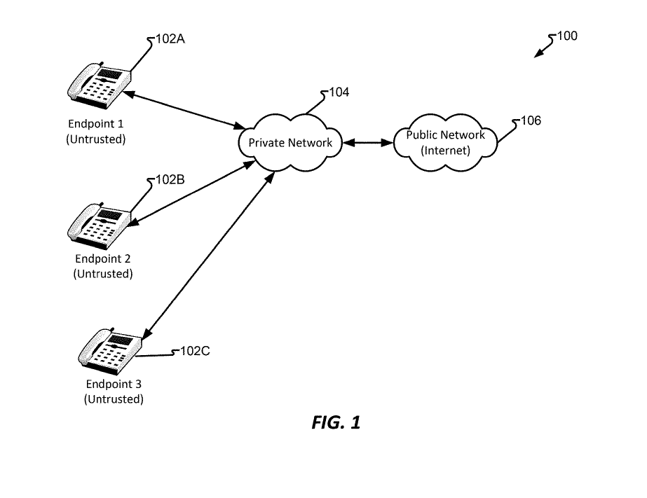

FIG. 1 depicts system 100 in accordance with embodiments of the present disclosure. In one embodiment, private network 104 has attached thereto, endpoints 102 which may, via public network 106 communicate with devices attached to public network 106. Upon attachment of endpoints 102 to private network 104, endpoints 102 are initially untrusted and may have at least some all functionality limited. For example, endpoints 102 may be authorized to communicate, via private network 104 and/or public network 106, in a limited capacity and for the sole purpose of becoming trusted, for example, only to communicate with those components necessary to allow endpoints 102 to become authorized.

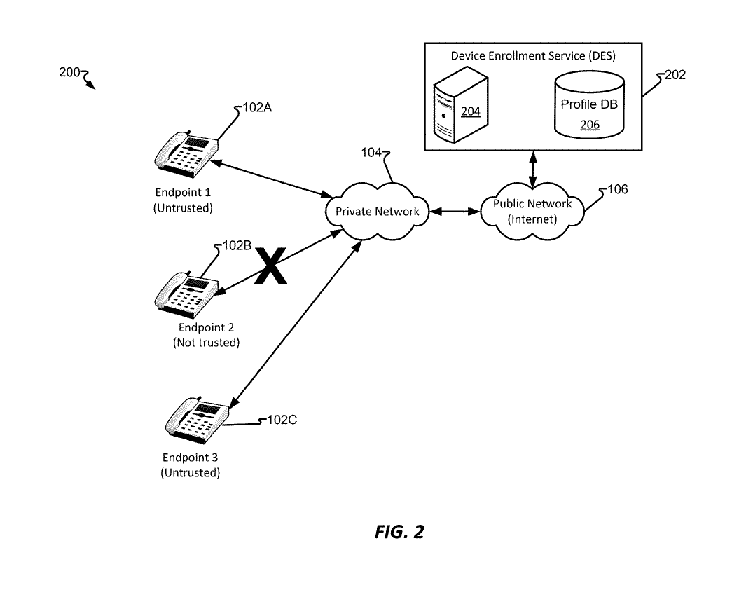

FIG. 2 depicts system 200 in accordance with embodiments of the present disclosure. In one embodiment, system 200 comprises components of system 100 and the addition of Device Enrollment Service (DES) 202. In one embodiment, DES 202 comprises server 204 in communication with profile database (profile DB) 206 accessible by one or more processors (not shown) of server 204 for the purposes maintaining data utilized by the one or more processors of server 204. It should be appreciated that, in another embodiment, server 204 and profile DB 206 may be integrated into a single device or distributed across a number of devices without departing from the scope of the embodiments provided herein. DES 202 is illustrated as being attached to private network 104 via public network 106 however, in another embodiment, DES 202 may be attached directly to private network 104. It should also be appreciated that private network 104 is variously embodied and may range from merely enough components to enable connectivity (e.g., cabling, router, switch, etc.) to connect endpoints 102 to public network 106 to extensive data processing, communications, data storage, security, and/or other processes whereby access to public network 106 is regulated, monitored, managed, and/or controlled and optionally provides other connectivity and/or data processing functionality.

System 200 depicts, in part, endpoint 102B being not trusted. Endpoint 102B may be determined to be untrusted upon attempted to communicate with an unauthorized (e.g., blacklisted) component on public network 106, store known or suspected malware, or otherwise exhibit a behavior that is associated with endpoint 102B being an unacceptable risk. Accordingly, DES 202 may disallow endpoint 102B from utilizing private network 104 and, therefore, be disallowed from further access to public network 106. For example, a switch or other component of private network 104 may logically and/or physically block communications having an origination and/or destination address associated with endpoint 102B.

In another embodiment, endpoints 102A, 102C are untrusted, or otherwise indicated has being capable of being trusted, but not yet becoming trusted. For example, being unauthenticated. Accordingly, endpoints 102A, 102C may be permitted to engaged in communications with components on private network 104 and/or public network 106, including but not limited to DES 202, for the purpose of becoming trusted.

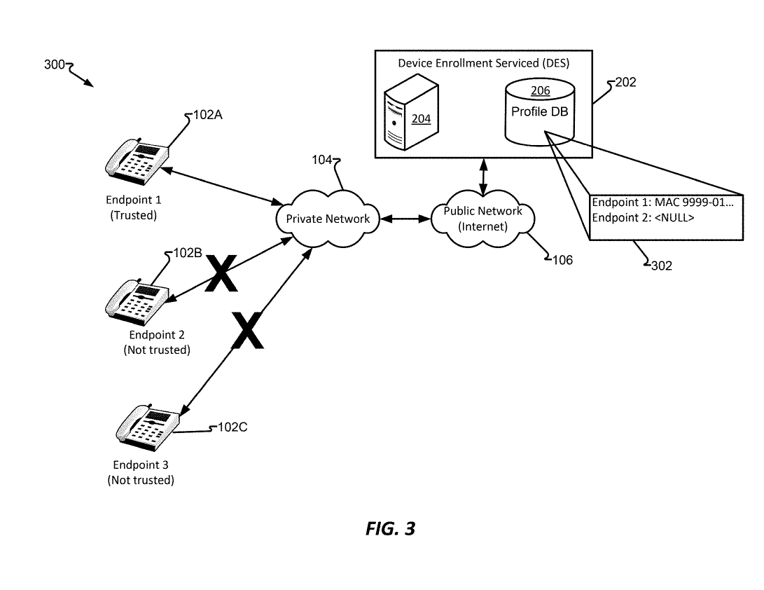

FIG. 3 depicts system 300 in accordance with embodiments of the present disclosure. In one embodiment, DES 202, such as profile DB 206, comprises record 302. In one embodiment, record 302 comprises an identifier (e.g., MAC address, serial number, etc.) that, during an authentication process, demonstrates that endpoint 102A is known to DES 202 and, thereby allowing endpoint 102A to be trusted. Trusted endpoint 102A may be permitted to be redirected, such as to another party as will be described more fully with respect to certain embodiments that follow.

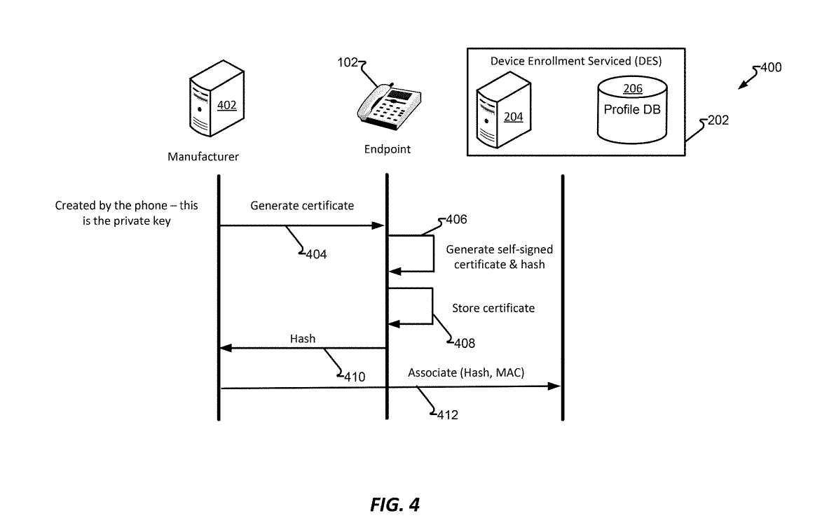

FIG. 4 depicts interaction 400 in accordance with embodiments of the present disclosure. In one embodiment, interaction 400 is performed as one of the last steps in a manufacturing process of endpoint 102. In one embodiment, interaction 400 depicts a portion of steps provided by manufacturer 402 of endpoint 102. In another embodiment, manufacturer 402 issues instruction 404 to endpoint 102 to generate a certificate. In response to instruction 404, endpoint 102 performs, at step 406, the generation of a self-signed certificate. In one embodiment, the self-signed certificate may be generated on one or more pieces of information specific to endpoint 102 (e.g., serial number, model number, date of manufacture, MAC address, private key, etc.). The private key associated with the certificate, in step 408, is stored internally to endpoint 102 and preferably never leaves endpoint 102. Step 406 also creates a hash of the certificate, such as using SHA256 or other hashing algorithm. In step 410, the hash, of the certificate, is provided to manufacture 402 which, in step 412, provides the hash and at least one identifier (e.g., MAC address, serial number, etc.) to DES 202. As will be seen with respect to embodiments that follow, a subsequent attempt to authenticate endpoint 102 may then comprise DES 202 comparing a hash from a certificate provided by a to-be-authenticated endpoint to a stored hash.

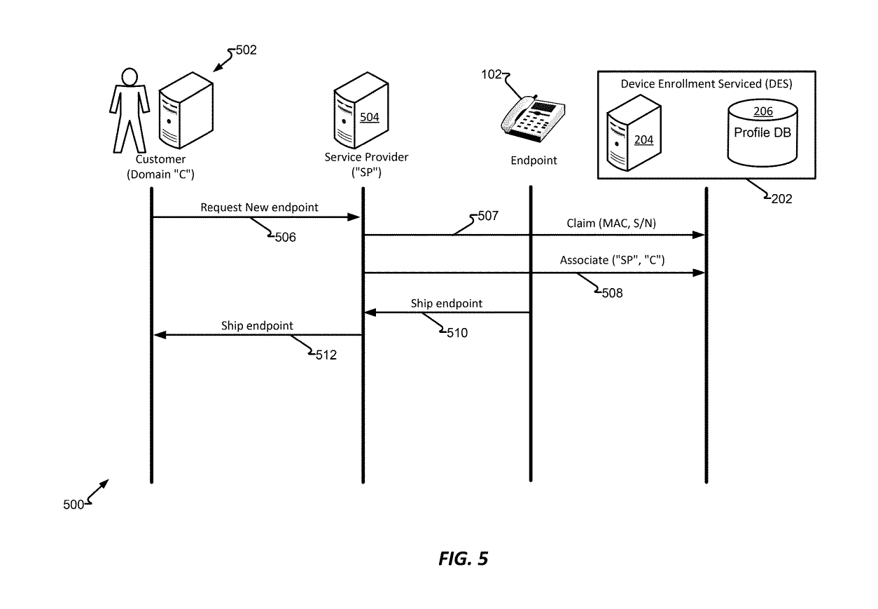

FIG. 5 depicts interaction 500 in accordance with embodiments of the present disclosure. Interaction 500 may be performed upon a customer ordering an endpoint from a service provider, such as customer 502 ordering endpoint 102 from service provider 504. In one embodiment, customer 502 (e.g., a computer and/or communication device and/or human utilizing the computer and/or communication device), at step 506, requests a new endpoint from service provider 504. Service provider 504 may “claim” an endpoint as one of its own in step 507, such as by providing an identifier (e.g., MAC address, serial number) or other identifier (such as an enrollment code) that DES 202 then associates endpoint 102 with service provider 504. It should be appreciated that step 507 may be performed prior to step 506. Service provider 504, sends a message, at step 508, to DES 202 to cause a record associated with service provider 504 to be created to associate service provider 504 with customer 502. Endpoint 510 is then prepared for shipping at step 510 and shipped to customer 502 in step 512.

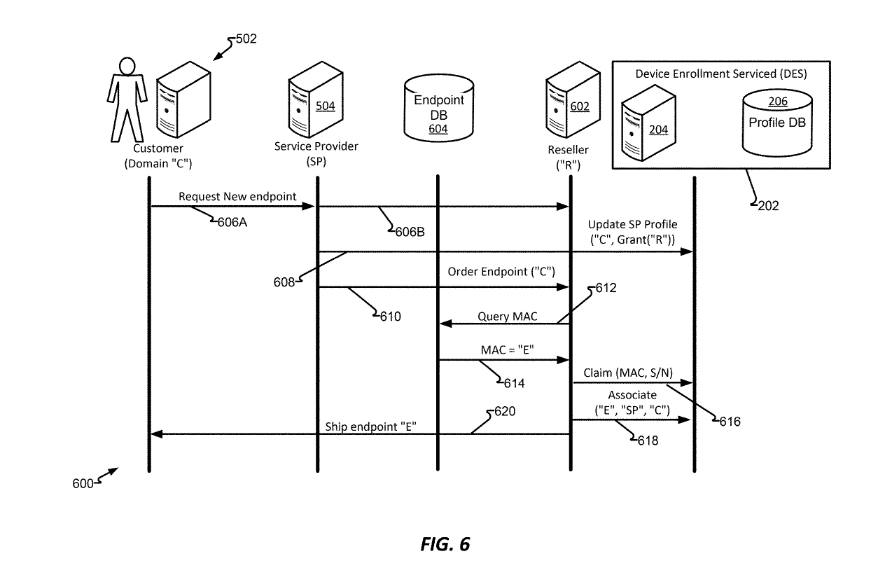

FIG. 6 depicts interaction 600 in accordance with embodiments of the present disclosure. Interaction 600 may be performed by a customer, such as customer 502, ordering and endpoint, such as endpoint 102 (not shown), from a service provider, such as service provider 504, wherein the endpoint is provided by a reseller. In one embodiment, customer 502 requests an endpoint in step 606 which may comprise portion 606A, being a request to service provider 504, and/or step 606B which then forwards the request to reseller 602. Service provider 608 causes, in step 608, DES 202 to update a record maintained by DES 202 and associated with service provider 504 to associate customer 502 with reseller 602, such that a grants permission for reseller 602 to associate endpoints with customer 502. Next, in step 610, service provider 502 orders an endpoint for customer 502 from reseller 602. In response, in step 612, reseller 602 queries endpoint database (endpoint DB) 604 to obtain an identifier (e.g., MAC address, serial number etc.) of the endpoint requested in step 606. In response, reseller 602 receives the MAC address (and/or other unique identifier) in step 614. Reseller 602 may “claim” an endpoint as one of its own in step 616, such as by providing an identifier (e.g., MAC address, serial number) or other identifier (such as an enrollment code) that DES 202 then associates endpoint 102 with reseller 602. Reseller 602 then causes DES 202 to associate the endpoint identifier, service provider, and customer in step 618. Reseller 602 ships the endpoint to customer 502 in step 620. It should be appreciated that step 620 may be performed at any point after step 606.

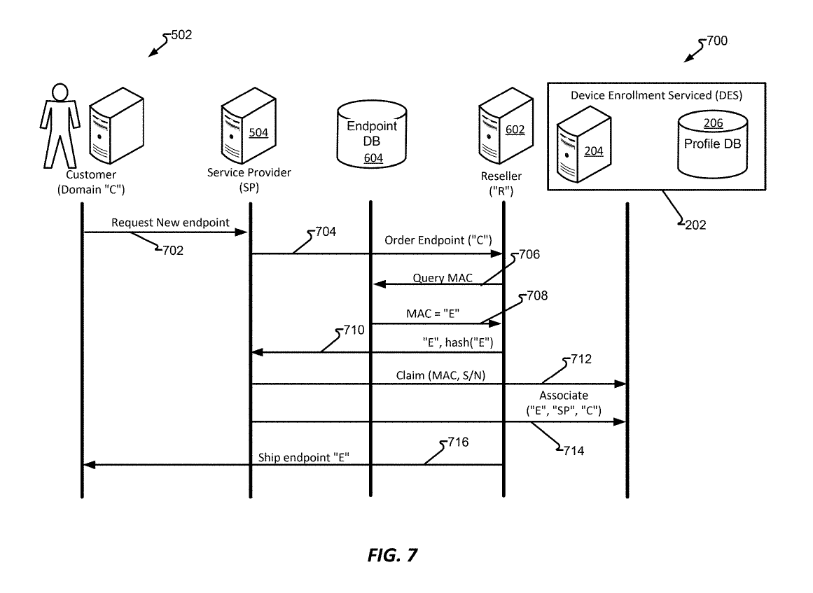

FIG. 7 depicts interaction 700 accordance with embodiments of the present disclosure. Interaction 600 may be performed by a customer, such as customer 502, ordering and endpoint, such as endpoint 102 (not shown), from a service provider, such as service provider 504, wherein the endpoint is provided by a reseller. In one embodiment, customer 502 orders a new endpoint from service provider 504 in step 702. In step 704, service provider 504 orders the requested endpoint from reseller 602.

Reseller 602 then queries endpoint DB 604 to obtain the MAC address (and/or other unique identifier), which is provided in step 708. Reseller 602 provides the MAC address and a hash of the MAC address to service provider 504 in step 710. Reseller 602 may “claim” an endpoint as one of its own in step 712, such as by providing an identifier (e.g., MAC address, serial number) or other identifier (such as an enrollment code) that DES 202 then associates endpoint 102 with reseller 602. Service provider 504, in step 714, then causes DEC 202 to associate the endpoint, service provider, and customer. Reseller then ships endpoint to customer 502 in step 716. It should be appreciated that step 716 may be performed at any point after step 702.

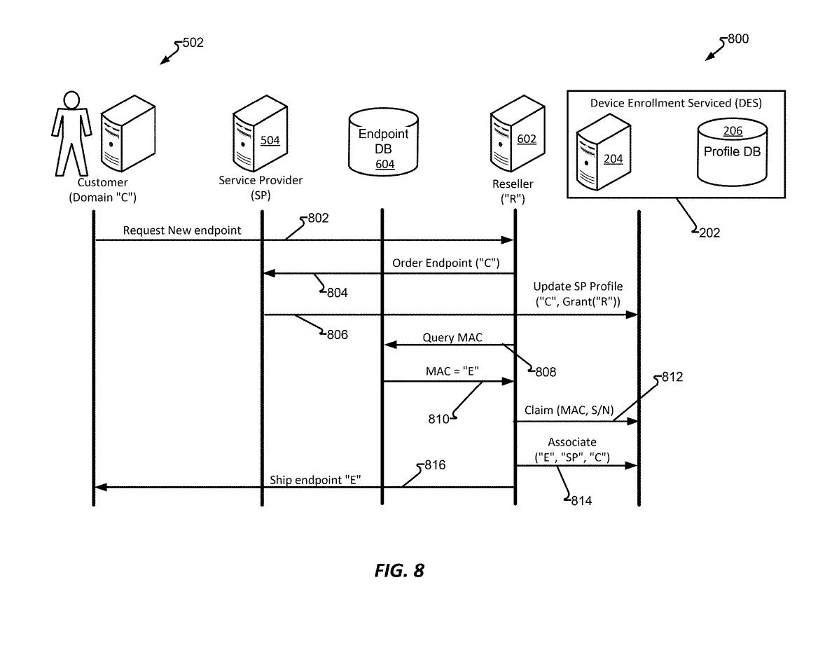

FIG. 8 depicts interaction 800 in accordance with embodiments of the present disclosure. Interaction 800 may be performed by a customer, such as customer 502, ordering and endpoint, such as endpoint 102 (not shown), from a reseller, such as reseller 602, wherein the endpoint is provided by a reseller. In one embodiment, customer 502 requests a new endpoint from reseller 602 in step 802. In response, reseller 602 orders a service from service provider 504 in step 804, the order being on behalf of customer 502. Service provider 504 then causes a record to be updated in DES 202 in step 806. The updated record indicates that, for customer 502, service provider 504 may associate endpoints with reseller 602. Reseller may query a data base in step 808 to obtain a MAC address for a particular endpoint and obtain the MAC address for the endpoint “E” in step 810. Service provider 504 may “claim” an endpoint as one of its own in step 812, such as by providing an identifier (e.g., MAC address, serial number) or other identifier (such as an enrollment code) that DES 202 then associates endpoint 102 with service provider 504.

Reseller 602, at step 814, then causes DES 202 to associate the endpoint with service provider 504 and customer 502. Reseller 602 then ships the endpoint to customer 502 in step 816. It should be appreciated that step 816 may occur at any point following step 802.

While certain embodiments incorporate shipping endpoints to a particular customer (e.g., customer 502), in other embodiments, the endpoint may be sent in advance of an order, such as to allow customer 502 to become familiar with certain aspects of the endpoint or in advance of a known or anticipated request for the endpoint. Therefore, in addition to or as an alternative to shipping, embodiments herein shipping may comprise activating endpoints or activating endpoints already on-site without departing from the scope of the embodiments herein.

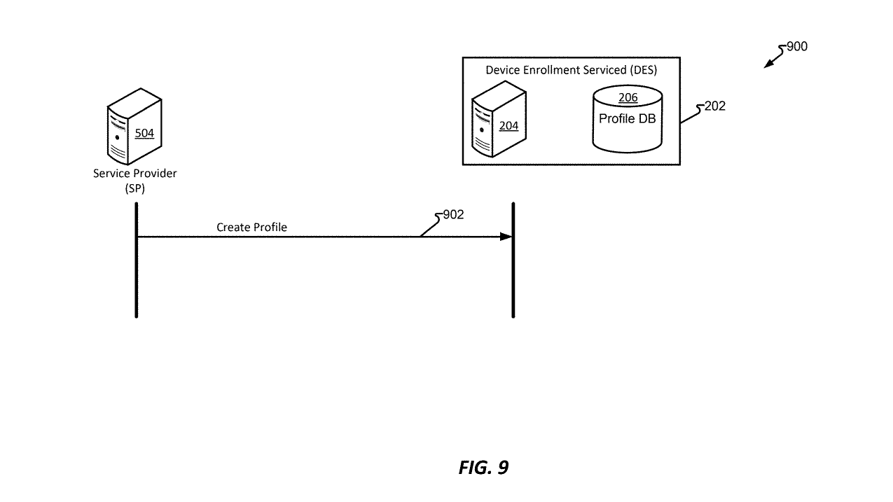

FIG. 9 depicts interaction 900 in accordance with embodiments of the present disclosure. In one embodiment, service provider 504 creates a profile, in step 902, on DES 202.

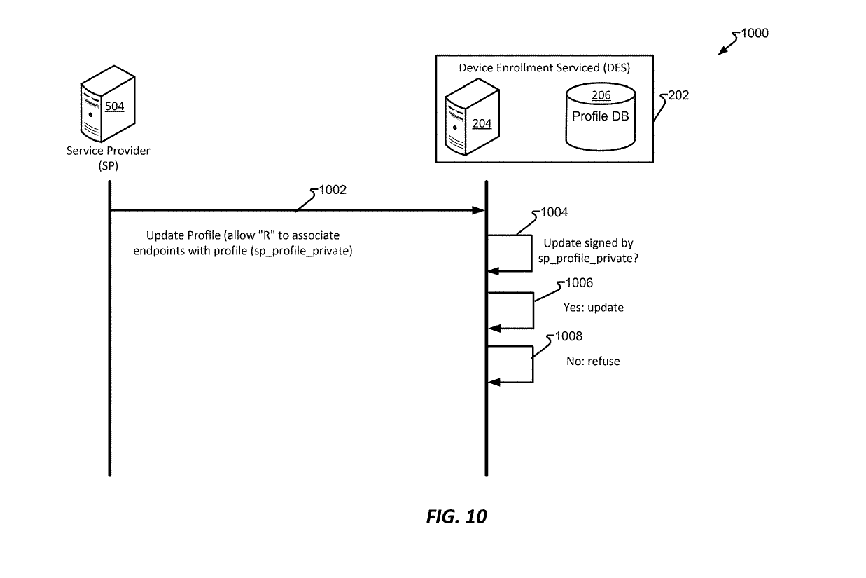

FIG. 10 depicts interaction 1000 in accordance with embodiments of the present disclosure. In one embodiment, service provider 504, in step 1002 updates the profile of service provider 504 (created in step 902) comprising, in step 1002, causing DES 202 to update the provide associated with service provider 504, such as to allow a particular reseller (e.g., one of reseller 602) to associate endpoints with service provider 504 as maintained by DES 202. In response to step 1002, at step 1004, DES 202 determines the request, at step 1002, was signed by the private key of the service provider. If yes, step 1006 executes the update and, if no at step 1008, the request is denied.

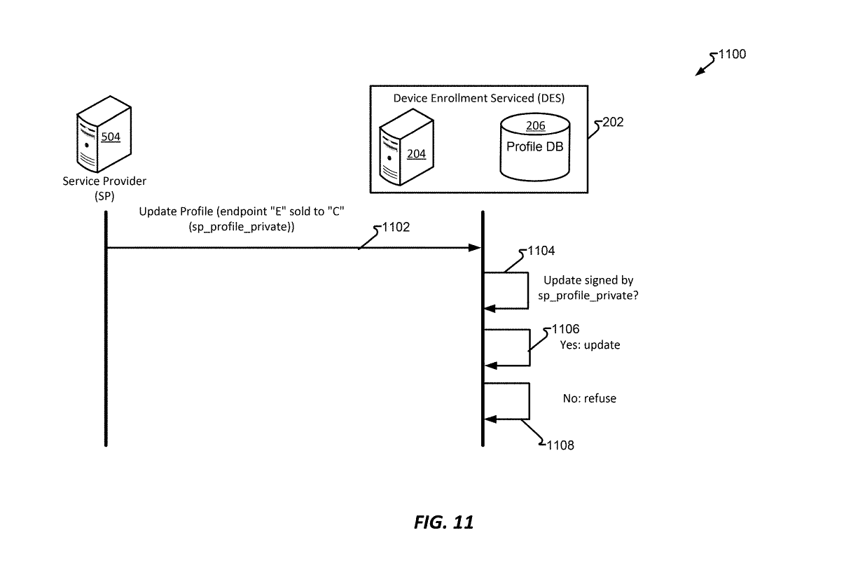

FIG. 11 depicts interaction 1100 in accordance with embodiments of the present disclosure. Interaction 1100 may occur when service provider 504 sells, delivers, or otherwise provides an endpoint to a customer. In step 1102, service provider 504 issues a request to DES 202 to update a profile associated with service provider 504, the request identifying the particular endpoint sold to a particular customer (e.g., one of customer 502). Step 1104 determines if the request received at step 1102 was signed by a private profile key of the service provider and, if yes, performs the update in step 1106 otherwise the request is refused in step 1108.

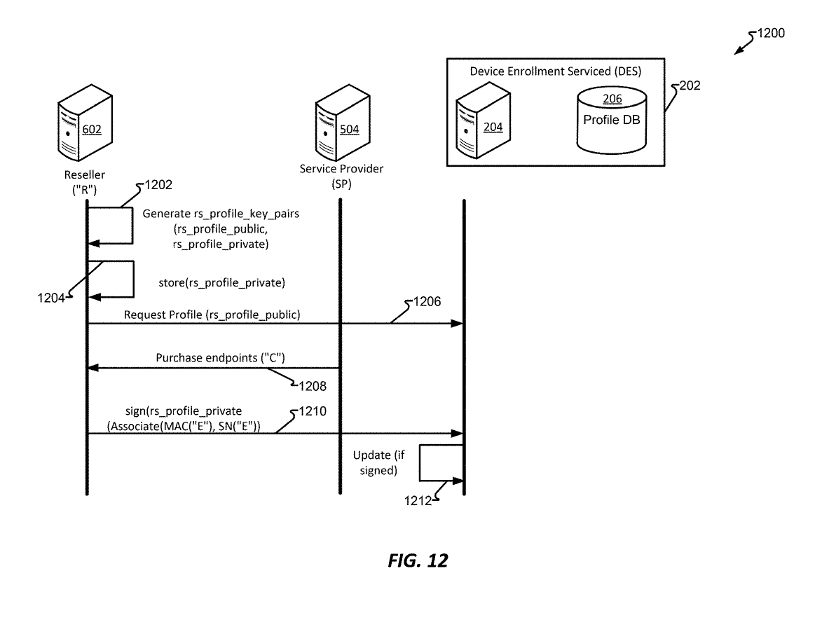

FIG. 12 depicts interaction 1200 in accordance with embodiments of the present disclosure. Interaction 1200 may occur to create a reseller profile on DES 202 for a particular reseller (e.g., one of reseller 602). In one embodiment, step 1202 is performed by reseller 602 generating a reseller private and public key-pair. In step 1204, reseller 602 stores the private key locally (and preferably securely). In step 1206, reseller 602 requests a profile from DES 202, the request being comprising the public key. When, as in step 1208, service provider 504 purchases endpoints from reseller 602 for a particular customer, reseller 602 sends a signed message, in step 1210, to DES 202. The signed message being signed with the private key and associating the MAC address, serial number, and/or other unique identifier. In response, in step 1212, DES 202 determines, via possession of the public key, that the request was signed with the reseller's private key and, if so, updates the record in accordance with the request received in step 1210.

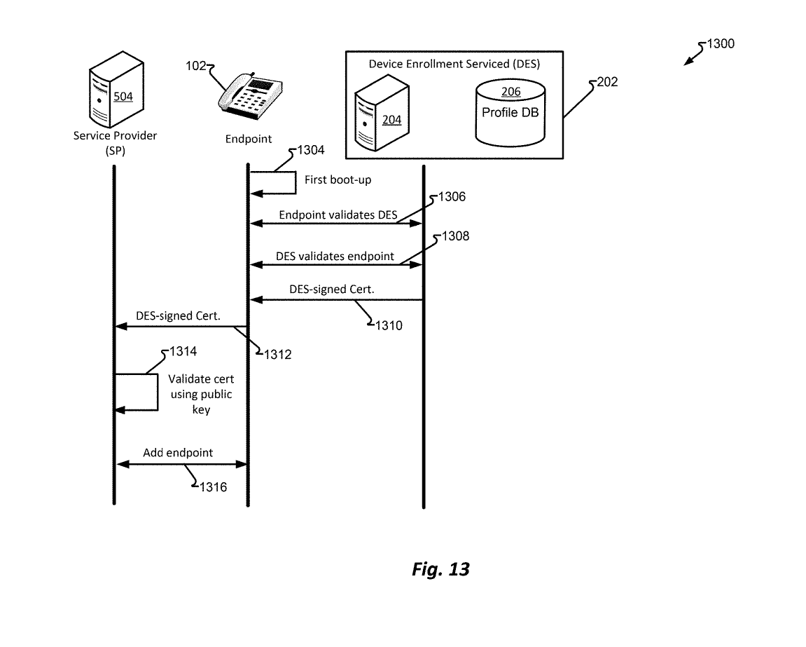

FIG. 13 depicts interaction 1300 for a first installation interaction in accordance with embodiments of the present disclosure. In one embodiment, endpoint 102 has been delivered or otherwise made available to a particular customer (one of customer 502) and is ready to be added to the network of the particular customer. In step 1304, endpoint 102 is booted-up for the first time (or at least the first time when attached to the network of the particular customer).

Following step 1304, endpoint 102 (via information stored within endpoint 102) initiates communication with DES 202 and performs steps 1306 and 1308 whereby endpoint 102 is validated to DES 202 and DES 202 is validated to endpoint 102, respectively. Steps 1306 and 1308 may be performed, as ordered, or alternatively, step 1308 then step 1306. Once endpoint 102 and DES 202 are authenticated to each other, DES 202 provides endpoint 102 with a DES signed certificate in step 1310. In one embodiment, the signature utilized in step 1310 is the public key of service provider 504 maintained in the profile of service provider 504 by DES 202.

Endpoint 102 provides the DES signed certificate to service provider 504 which, at step 1314, validates the certification utilizing the public key of service provider 504. With validation proven at step 1314, step 1316 then adds endpoint 102 to a list of trusted endpoints operable to utilize the network of a particular customer.

As a benefit of embodiments provided herein, a trusted endpoint 102 may be allowed to be redirected to other servers, such as a server of service provider 504 and/or reseller 602. An untrusted, or not-trusted endpoint 102, may have malware attempting to redirect endpoint 102 to a malicious or otherwise unauthorized address, however, absent validation and trust of endpoint 102, end point 102 may remain isolated and unable to communicate. Similarly, service provider 504 and/or reseller 602 receiving a communication from an endpoint that has not been verified (e.g., is unknown) may have such communications ignored (e.g., blacklisted) and assumed to be malicious or at least unauthorized or untrusted.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (e.g., GPU, CPU), or logic circuits programmed with the instructions to perform the methods (e.g., FPGA). In another embodiment, a processor may be a system or collection of processing hardware components, such as a processor on a client device and a processor on a server, a collection of devices with their respective processor, or a shared or remote processing service (e.g., “cloud” based processor). A system of processors may comprise task-specific allocation of processing tasks and/or shared or distributed processing tasks. In yet another embodiment, a processor may execute software to provide the services to emulate a different processor or processors. As a result, first processor, comprised of a first set of hardware components, may virtually provide the services of a second processor whereby the hardware associated with the first processor may operate using an instruction set associated with the second processor.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJS™ processors, other industry-equivalent processors, and may perform computational functions using any known or future-developed standard, instruction set, libraries, and/or architecture.

Any of the steps, functions, and operations discussed herein can be performed continuously and automatically.
The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.
Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., processors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a processor may comprise a first processor on one component and a second processor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.
Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.
Also, while the flowcharts have been discussed and illustrated in relation to a particular sequence of events, it should be appreciated that changes, additions, and omissions to this sequence can occur without materially affecting the operation of the invention.
In yet another embodiment, the systems and methods of this invention can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, teleendpoints (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.
In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.
In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.
Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.
The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.
The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.
Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system, comprising:
a network interface;
a data storage comprising a non-volatile portion;
a processor; and
wherein, the processor, upon determining a first attachment to a network:
accesses a first address within the data storage;
attempt mutual authentication with a first service provided at the first address;
upon successfully performing mutual authentication with the first service, receiving from the first service a certificate a second address and a signed certificate; and
reconfiguring the system to communicate with a second service at the second address.

2. The system of claim 1, wherein the processor further provides the second service with the signed certificate to be authenticated by the second service.

3. The system of claim 1, wherein the processor, upon receiving a request to generate a self-signed certificate, generates a self-signed certificate and a hash of the self-signed certificate and provides the hash to the first service.

4. The system of claim 3, wherein the system provides the hash to the first service via providing the hash to a manufacture of the system for forwarding to the first service.

5. The system of claim 1, wherein the self-signed certificate comprises the first address.

6. The system of claim 1, wherein the processor, following successfully mutual authentication, establishes a secure channel with the first service to receive the signed certificate.

7. A system, comprising:
a data storage;
a processor;
a network interface; and
wherein the processor:
receives, via the network interface, a request for mutual authentication from an endpoint;
in response to the received request, performs mutual authentication with the endpoint;
upon successfully performing the mutual authentication, providing the endpoint with a certificate to enable the endpoint to utilize a network.

8. The system of claim 7, further comprising generating the certificate signed by the system utilizing a public key of the system.

9. The system of claim 7, wherein processor receives a unique identifier of the endpoint from a manufacture of the endpoint.

10. The system of claim 7 wherein the unique identifier is a Media Access Control (MAC) address.

11. The system of claim 7 wherein the processor receives a hash of the certificate from a manufacture of the endpoint.

12. The system of claim 11, wherein the processor utilizes the hash of the certificate to perform the mutual authentication.

13. The system of claim 7, wherein the data storage maintains a record identifying a service provider with a customer.

14. The system of claim 13, wherein the record is updated upon receiving, from the service provider, a request to associate a third party with the service provider.

15. The system of claim 14, wherein the request further identifies a customer.

16. The system of claim 14, further comprising:
receiving a request to from a reseller to update a record that associate an endpoint with a service provider for a customer; and
upon determining that the data storage maintains a record granting permission for the update, performing the update.

17. A system, comprising:
a data storage;
a processor;
a network interface; and
wherein the processor:
receives, via the network, a certificate from an endpoint;
upon receiving the certificate, validates the certificate utilizing a public key maintained in the data storage; and
upon successfully validating the certificate, adding the endpoint to a list of trusted endpoints to thereby enable the endpoint to utilize a network.

18. The system of claim 17, wherein the network is a network of a client utilizing the endpoint.

19. The system of claim 17, wherein the certificate is provided by a manufacture of the endpoint.

20. The system of claim 17, wherein the processor further receives, via the network, notification from a reseller that an endpoint is to be assigned to a customer and, in response thereto, the system notifies a device enrollment service (DES) to update a profile stored therein such that when the DES is queried the endpoint is known and known to be associated with the customer.
